(19) United States
(12) Patent Application Publication
(10) Pub. No.: US 2025/0174723 A1
(43) Pub. Date: May 29, 2025

(54) AQUEOUS BATTERY

(71) Applicant: TOYOTA JIDOSHA KABUSHIKI KAISHA, Toyota-shi (JP)

(72) Inventors: Hiroshi SUYAMA, Mishima-shi (JP); Makio Kon, Mishima-shi (JP); Bunta Tanaka, Fuji-shi (JP); Shigeki Sato, Fujinomiya-shi (JP); Tomoya Matsunaga, Susono-shi (JP)

(73) Assignee: TOYOTA JIDOSHA KABUSHIKI KAISHA, Toyota-shi (JP)

(21) Appl. No.: 18/937,052

(22) Filed: Nov. 5, 2024

(30) Foreign Application Priority Data
Nov. 27, 2023 (JP) 2023-200151

(51) Int. Cl. H01M 10/0568; H01M 10/0569

(52) U.S. Cl. CPC H01M 10/0568; H01M 10/0569

(57) ABSTRACT

An aqueous battery includes a positive electrode containing a positive electrode active material; a negative electrode containing a negative electrode active material; and an aqueous electrolytic solution provided between the positive electrode and the negative electrode, the negative electrode active material contains a hydrogen storage alloy, and the aqueous electrolytic solution contains: a solvent containing water; and a potassium salt of a phosphorus oxoacid that is dissolved in the solvent, and represented by the general formula K₂₊ₙPₙO₃ₙ₊₁, wherein n is an integer of 1 or more.

### CROSS-REFERENCE TO RELATED APPLICATION

This application claims priority to Japanese Patent Application No. 2023-200151 filed on Nov. 27, 2023, incorporated herein by reference in its entirety.

### BACKGROUND

### 1. Technical Field

The disclosure relates to an aqueous battery.

### 2. Description of Related Art

Regarding an aqueous battery, Japanese Unexamined Patent Application Publication No. 2019-220294 describes an aqueous potassium-ion battery including an aqueous electrolytic solution containing potassium pyrophosphate.

### SUMMARY

A practical active material system for an aqueous battery including an aqueous electrolytic solution containing a potassium salt of a phosphorus oxoacid, such as pyrophosphoric acid, has, however, not been established yet.

The present disclosure provides a chargeable-dischargeable aqueous battery including a novel combination of an aqueous electrolytic solution containing a potassium salt of a phosphorus oxoacid and a negative electrode active material.

One embodiment of the present disclosure relates to an aqueous battery including a positive electrode containing a positive electrode active material, a negative electrode containing a negative electrode active material, and an aqueous electrolytic solution provided between the positive electrode and the negative electrode, in which the negative electrode active material contains a hydrogen storage alloy, and the aqueous electrolytic solution contains a solvent containing water, and a potassium salt of a phosphorus oxoacid that is dissolved in the solvent, and represented by a general formula K₂₊ₙPₙO₃ₙ₊₁, wherein n is an integer of 1 or more.

The present disclosure can provide a chargeable-dischargeable aqueous battery including a novel combination of an aqueous electrolytic solution containing a potassium salt of a phosphorus oxoacid and a negative electrode active material.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view schematically illustrating an aqueous battery 10 according to one embodiment;

FIG. 2A illustrates graphs illustrating charge-discharge characteristics (upper graph) and cycle characteristics (lower graph) obtained in Example 1;

FIG. 2B illustrates graphs illustrating charge-discharge characteristics (upper graph) and cycle characteristics (lower graph) obtained in Example 2;

FIG. 2C illustrates graphs illustrating charge-discharge characteristics (upper graph) and cycle characteristics (lower graph) obtained in Example 3;

FIG. 3A illustrates graphs illustrating charge-discharge characteristics (upper graph) and cycle characteristics (lower graph) obtained in Example 4;

FIG. 3B illustrates graphs illustrating charge-discharge characteristics (upper graph) and cycle characteristics (lower graph) obtained in Example 5;

FIG. 3C illustrates graphs illustrating charge-discharge characteristics (upper graph) and cycle characteristics (lower graph) obtained in Comparative Example 1;

FIG. 4A illustrates graphs illustrating charge-discharge characteristics (upper graph) and cycle characteristics (lower graph) obtained in Comparative Example 2;

FIG. 4B illustrates graphs illustrating charge-discharge characteristics (upper graph) and cycle characteristics (lower graph) obtained in Comparative Example 3;

FIG. 4C illustrates graphs illustrating charge-discharge characteristics (upper graph) and cycle characteristics (lower graph) obtained in Comparative Example 4;

FIG. 5 illustrates graphs illustrating charge-discharge characteristics (upper graph) and cycle characteristics (lower graph) obtained in Reference Example 1;

FIG. 6A illustrates graphs illustrating charge-discharge characteristics (upper graph) and cycle characteristics (lower graph) obtained in Example 6;

FIG. 6B illustrates graphs illustrating charge-discharge characteristics (upper graph) and cycle characteristics (lower graph) obtained in Example 7; and

FIG. 6C illustrates graphs illustrating charge-discharge characteristics (upper graph) and cycle characteristics (lower graph) obtained in Comparative Example 5.

### DETAILED DESCRIPTION OF EMBODIMENTS

Hereinafter, embodiments of the present disclosure will be described with reference to the accompanying drawings. The present disclosure is, however, not limited to these embodiments. It is noted that the drawings do not always reflect accurate dimensions. Besides, some symbols may be omitted in the drawings. Herein, the phrase “A to B” relating numerical values A and B means “A or more and B or less” unless otherwise specified. In this phrase, if only the numerical value B is provided with a unit, the unit is intended to be applied also to the numerical value A. Besides, the term “or” means a logical sum unless otherwise specified. The phrase “E₁ and/or E₂” relating elements E₁ and E₂ means “E₁ or E₂, or a combination thereof”. The phrase “E₁, . . . , E_{N-1}, and/or E_{N}” relating elements E₁, . . . , and E_{N} (wherein N is an integer of 3 or more) means “E₁, . . . , E_{N-1}, or E_{N}, or a combination thereof”.

### Aqueous Battery

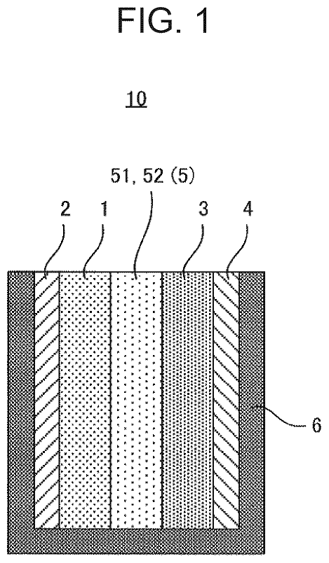

FIG. 1 is a sectional view schematically illustrating an aqueous battery 10 according to one embodiment (hereinafter, sometimes simply referred to as the “battery 10”). In FIG. 1, the battery 10 is simplified, and terminals and a part of an external material are not illustrated. The battery 10 includes a positive electrode layer 1, a positive electrode current collector 2 connected to the positive electrode layer 1, a negative electrode layer 3, a negative electrode current collector 4 connected to the negative electrode layer 3, and an electrolyte layer 5 disposed between the positive electrode layer 1 and the negative electrode layer 3, and further includes the external material 6 for housing these elements. The aqueous battery 10 can function also as a secondary battery.

### Positive Electrode Layer

The positive electrode layer 1 is a layer containing at least a positive electrode active material. In one embodiment, the positive electrode layer 1 may further contain a conductive aid. The positive electrode layer 1 may further contain an additive such as a binder (binding material) if necessary. The thickness of the positive electrode layer 1 is not especially limited, and can be 0.1 μm to 1 mm, or 1 to 100 μm in one embodiment.

As the positive electrode active material, one positive electrode active material may be singly used, or two or more positive electrode active materials may be used in combination. In one embodiment, the positive electrode layer 1 can contain a positive electrode active material capable of storing and releasing a proton (hydrogen ion H⁺). Examples of the positive electrode active material capable of storing and releasing a proton include nickel hydroxide, nickel oxyhydroxide, nickel oxide, manganese dioxide, molybdenum trioxide, poly(aminoanthraquinone) (PNAQ), perylene-3,4,9,10-tetracarboxylic-3,4:9,10-dianhydride (PTCDA), pyrene-4,5,9,10-tetraone (PYT), poly(diphenoxyphosphazene) (PDPZ), a Prussian blue derivative, and a combination of these.

In another embodiment, the positive electrode layer 1 can contain a positive electrode active material capable of storing and releasing a potassium ion (K⁺). Examples of the positive electrode active material capable of storing and releasing a potassium ion include a potassium cobalt composite oxide (such as KCoO₂), a potassium nickel composite oxide (such as KNiO₂), a potassium nickel titanium composite oxide (such as KNi_{1/2}Ti_{1/2}O₂), a potassium nickel manganese composite oxide (such as KNi₁₂Mn_{1/2}O₂, or Kni_{1/3}Mn_{2/3}O₂), a potassium manganese composite oxide (such as KMnO₂, or KMn₂O₄), a potassium iron manganese composite oxide (such as K_{2/3}Fe_{1/3}Mn_{2/3}O₂), a potassium nickel cobalt manganese composite oxide (such as KNi_{1/3}Co_{1/3}Mn_{1/3}O₂), a potassium iron composite oxide (such as KFeO₂), a potassium chromium composite oxide (such as KCrO₂), a potassium iron phosphate compound (such as KFePO₄), a potassium manganese phosphate compound (such as KMnPO₄), a potassium cobalt phosphate compound (KCoPO₄), and Prussian blue. The positive electrode active material may be a solid solution of these, or a compound having a non-stoichiometric composition.

In still another embodiment, the positive electrode layer 1 can contain, as the positive electrode active material, potassium titanate, TiO₂, LiTi₂(PO₄)₃, sulfur(S), or the like that exhibits a nobler potential as the charge-discharge potential than a negative electrode active material described later.

The shape of the positive electrode active material can be, for example, a particle or thin film shape. From the viewpoint of ionic conductivity and electronic conductivity, the primary particle size of the positive electrode active material can be 1 nm to 100 μm, or 5 nm to 30 μm, or 10 nm to 10 μm in one embodiment. Primary particles of the positive electrode active material may agglomerate to form secondary particles. From a similar viewpoint, the particle size of the secondary particle of the positive electrode active material can be 0.1 to 500 μm, or 0.5 to 100 μm, or 1 to 20 μm in one embodiment. The content of the positive electrode active material in the positive electrode layer 1 is not especially limited, and from a similar viewpoint, the content can be 20 to 99% by mass, or 40 to 99% by mass, or 60 to 97% by mass, or 70 to 95% by mass with respect to the total amount (100% by mass) of the positive electrode layer 1 in one embodiment.

As the conductive aid, one conductive aid may be singly used, or two or more conductive aids may be used in combination. As the conductive aid, any conductive aid capable of withstanding the environment of charge-discharge of an aqueous electrolyte secondary battery can be used. Examples of the conductive aid that can be added to the positive electrode layer 1 include carbon materials such as Ketjen black (KB), vapor-grown carbon fiber (VGCF), acetylene black (AB), carbon nanotube (CNT), carbon nanofiber (CNF), carbon black, coke, and graphite. Other examples of the conductive aid that can be added to the positive electrode layer 1 include metal materials capable of withstanding the environment of charge-discharge of an aqueous electrolyte secondary battery. The shape of the conductive aid can be, for example, a powder or fiber shape. The amount of the conductive aid contained in the positive electrode layer 1 is not especially limited, and from the viewpoint of the ionic conductivity and the electronic conductivity, the amount can be 0.1 to 50% by mass, or 0.5 to 30% by mass, or 1 to 10% by mass with respect to the total amount (100% by mass) of the positive electrode layer 1 in one embodiment.

Regarding the binder (binding material), one binder may be singly used, or two or more binders may be used in combination. As the binder, a binder capable of withstanding the environment of charge-discharge of an aqueous electrolyte secondary battery can be used. The binder plays a role of causing the active material or the conductive aid to stay on the surface of the current collector 2, and retaining a conductive network in the electrode. Examples of the binder include styrene butadiene rubber (SBR), carboxymethylcellulose (CMC), acrylonitrile butadiene rubber (ABR), butadiene rubber (BR), polyvinylidene fluoride (PVDF), and polytetrafluoroethylene (PTFE). The amount of the binder contained in the positive electrode layer 1 is not especially limited, and from the viewpoints of the ionic conductivity and the electronic conductivity, and appropriate binding of the positive electrode active material, the amount can be 0.1 to 50% by mass, or 0.5 to 30% by mass, or 1 to 10% by mass with respect to the total amount (100% by mass) of the positive electrode layer 1 in one embodiment.

### Positive Electrode Current Collector

The positive electrode current collector 2 is a conductor connected to the positive electrode layer 1. The positive electrode current collector 2 can be constituted by a known metal or the like usable as a positive electrode current collector of an aqueous secondary battery. Examples of such a metal include metal materials containing one or more elements selected from Cu, Ni, Al, V, Au, Pt, Mg, Fe, Ti, Pb, Co, Cr, Zn, Ge, In, Sn, and Zr. Examples of the shape of the positive electrode current collector 2 include plate, foil, mesh, and porous shapes. As another example, a member including a conductive or electrically insulating substrate (such as a resin film), and the metal material deposited or plated on the surface of the substrate may be used as the positive electrode current collector 2.

### Negative Electrode Layer

The negative electrode layer 3 is a layer containing at least a negative electrode active material. In one embodiment, the negative electrode layer 3 can further contain a conductive aid. The negative electrode layer 3 may further contain an additive such as a binder if necessary. The thickness of the negative electrode layer 3 is not especially limited, and in one embodiment, the thickness can be 0.1 μm to 1 mm, or 1 to 100 μm.

Regarding the negative electrode active material, one negative electrode active material may be singly used, or two or more negative electrode active materials may be used in combination. In the aqueous battery 10, the negative electrode layer 3 contains a hydrogen storage alloy as the negative electrode active material. A hydrogen storage alloy is an alloy in which formation of a metal hydride reversibly proceeds through a reaction between the alloy and hydrogen, and can reversibly store and release hydrogen through the reaction. Examples of the hydrogen storage alloy include hydrogen storage alloys of various types such as AB₅-type (such as LaNi₅), AB-type having a superlattice structure (such as TiCo, or ZrCo), AB₂-type (such as ZrV_{0.4}Ni_{1.5}), and A₂B₇-type (such as La₂Ni₇). Such a hydrogen storage alloy is constituted by a combination of an element occupying a site A and having high affinity with hydrogen (hereinafter referred to as the “element A”), and an element occupying a site B, and having low affinity with hydrogen but playing a role of reducing a temperature necessary for a reaction by lowering activation energy of the metal hydride generation reaction and the reverse reaction (hereinafter referred to as the “element B”). Examples of the element A include rare earth elements (such as La), Ca, Mg, Ti, Zr, V, Nb, Pt, and Pd. Examples of the element B include Fe, Ni, Mn, Co, Cr, Cu, and Al. In one embodiment, a misch metal, that is, an alloy containing one or a plurality of rare earth elements, can be used as the element A. An example of such a hydrogen storage alloy includes a MmNis-based alloy that is an AB₅-type hydrogen storage alloy. Here, “Mm” means a misch metal. Examples of the metal elements included in the misch metal (Mm) include La, Ce, Nd, Sm, and Pr. In one embodiment, a misch metal Mm may further contain an alkaline earth element such as Mg, Sr, or Ca, and/or a transition metal element such as V, Cr, Fe, or Cu. Preferable examples of the MmNi₅-based alloy include MmNi₅₋ₓ(Co, Mn, Al)ₓ and MmNi₅₋ₓ(Co, Mn, Al, Fe) x, wherein x is a real number satisfying 0<x<5, in which a part of nickel (Ni) is substituted by another element B such as Co, Mn, or Al.

Other examples of the hydrogen storage alloy include a magnesium-based hydrogen storage alloy such as Mg₂Ni, or Mg₂Cu; a titanium-based hydrogen storage alloy such as Ti—Fe, Ti—Cr, Ti—Mn, Ti—Ni, or Ti—Cu; and a rare earth-Mg—Ni—based alloy such as Ln₁₋ₓMgₓNi_{y-z}Al_{z}, wherein Ln represents one or more elements selected from a rare earth element such as La, Sc, Y, Ti, and Zr; each of x, y, and z represents a real number; 0.05≤x≤0.30, 2.8≤y≤3.8, and 0.05≤z≤0.30. These hydrogen storage alloys may further include, on a material surface, a surface catalyst phase of Ni, Pd, Pt or the like for further increasing charge-discharge reaction activity. Such a surface catalyst phase can be provided by a conventionally known method. Particularly in a material system easily forming a strong oxide film, such as a Ti—Cr-based material, the surface catalyst phase is preferably provided.

A hydrogen storage alloy particle having a catalyst phase on the surface can be produced by a conventionally known method. Examples of a method for covering a base material particle with the surface catalyst phase include a PVD (physical vapor deposition) method such as a sputtering method or a vacuum deposition method; and a CVD (chemical vapor deposition) method such as a thermal CVD method.

Alternatively, a Ni catalyst phase can be provided on the surface of a hydrogen storage alloy particle containing Ni by successively performing an acid treatment process and a washing process. In the acid treatment process, a hydrogen storage alloy powder is subjected to an acid treatment. For example, an acid at normal temperature of 15° C. to 25° C. is prepared, and the hydrogen storage alloy powder is added to a container holding this acid, followed by stirring for a prescribed period of time. On the surface of the hydrogen storage alloy particle having been subjected to this acid treatment, components except for Ni, such as a rare earth element, Mg, and Al, are dissolved by the acid, and Ni difficult to be dissolved by the acid remains to form a Ni-rich surface catalyst phase. Inside the surface catalyst phase, a core portion of the hydrogen storage alloy having a prescribed alloy composition is present. After completing the stirring for a prescribed period of time, water in a double amount of the acid is added to the container, followed by stirring again for a prescribed period of time. Thereafter, the resultant mixture of the acid and water held in the container is allowed to stand still, and kept until the hydrogen storage alloy powder settles down. After the hydrogen storage alloy powder settles down, a supernatant of the mixture is removed, and thus, the acid treatment is completed. Thereafter, in the washing process, the hydrogen storage alloy particle is washed with water and/or an alkaline aqueous solution to remove the acid component. The temperature of the washing solution can be, for example, 15 to 60° C. Thereafter, the hydrogen storage alloy powder is separated from the washing solution.

Alternatively, for example, a Pd or Pt catalyst phase can be provided on the surface of the hydrogen storage alloy particle by adding a hydrogen storage alloy powder to an aqueous solution containing a Pd ion or a Pt ion, and stirring the resultant under reducing conditions. A reducing agent may be added to and mixed with the aqueous solution. After completing the reaction, an impurity such as a salt may be removed by washing.

In one embodiment, as the negative electrode active material contained in the negative electrode layer 3, an A₂B₇-type hydrogen storage alloy (such as La₂Ni₇) can be preferably used.

The shape of the negative electrode active material can be, for example, a particle, or thin film shape. From the viewpoint of the ionic conductivity and the electronic conductivity, the primary particle size of the negative electrode active material is 1 nm to 100 μm, or 5 nm to 30 μm, or 10 nm to 10 μm in one embodiment. Primary particles of the negative electrode active material may agglomerate to form secondary particles. From a similar viewpoint, the particle size of the secondary particle of the negative electrode active material can be 0.1 to 500 μm, or 0.5 to 100 μm, or 1 to 20 μm in one embodiment. The content of the negative electrode active material in the negative electrode layer 3 is not especially limited, and from a similar viewpoint, the content can be 20 to 99% by mass, or 40 to 99% by mass, or 60 to 97% by mass, or 70 to 95% by mass with respect to the total amount (100% by mass) of the negative electrode layer 3 in one embodiment.

As a conductive aid to be used in the negative electrode layer 3, the conductive aids described regarding the positive electrode layer 1 can be similarly used. One conductive aid may be singly used, or two or more conductive aids may be used in combination. The shape of the conductive aid can be, for example, a powder or fiber shape. The amount of the conductive aid contained in the negative electrode layer 3 is not especially limited, and from the viewpoint of the ionic conductivity and the electronic conductivity, the amount can be 0.1 to 50% by mass, or 0.5 to 30% by mass, or 1 to 10% by mass with respect to the total amount (100% by mass) of the negative electrode layer 3 in one embodiment.

As a binder to be used in the negative electrode layer 3, the binders described regarding the positive electrode layer 1 can be similarly used. One binder may be singly used, or two or more binders may be used in combination. The amount of the binder contained in the negative electrode layer 3 is not especially limited, and from the viewpoint of the ionic conductivity and the electronic conductivity, the amount can be 0.1 to 50% by mass, or 0.5 to 30% by mass, or 1 to 10% by mass with respect to the total amount (100% by mass) of the negative electrode layer 3 in one embodiment.

### Negative Electrode Current Collector

The negative electrode current collector 4 is a conductor connected to the negative electrode layer 3. The negative electrode current collector 4 can be constituted by a known metal or the like usable as the negative electrode current collector of an aqueous secondary battery. Examples of such a metal include a metal material containing one or more elements selected from Cu, Ni, Al, V, Au, Pt, Mg, Fe, Ti, Pb, Co, Cr, Zn, Ge, In, Sn, and Zr. In consideration of stability and the like in an aqueous electrolytic solution, the negative electrode current collector 4 may contain one or more elements selected from Al, Ti, Pb, Zn, Sn, Mg, Zr, and In. The negative electrode current collector 4 may contain one or more elements selected from Ti, Pb, Zn, Sn, Mg, Zr, and In. The negative electrode current collector 4 may contain Ti. Al, Ti, Pb, Zn, Sn, Mg, Zr, and In all have a low work function, and even when contact an aqueous electrolytic solution, electrolysis of the aqueous electrolytic solution is probably difficult to occur. Examples of the shape of the negative electrode current collector 4 include plate, foil, mesh, and porous shapes. As another example, a member including a conductive or electrically insulating substrate (such as a resin film), and the metal material deposited or plated on the surface of the substrate may be used as the negative electrode current collector 4. In one embodiment, from the viewpoint of increasing a dielectric withstand voltage on the reduction side of the aqueous electrolytic solution, the negative electrode current collector 4 may include a conductive member (such as a foil, a mesh, a porous plate, or a metal-plated resin film) containing the metal material, and a covering layer containing a carbon material and provided on the surface of the conductive member. The negative electrode 3 may be disposed in contact with the covering layer. Examples of the carbon material include the various carbon materials described above as the examples of the conductive aid that can be added to the positive electrode layer 1 and the negative electrode layer 3.

### Electrolyte Layer

The electrolyte layer 5 includes a separator 51 provided between the positive electrode layer 1 and the negative electrode layer 3, and an aqueous electrolytic solution 52 impregnated in the separator 51 (hereinafter, sometimes referred to as the “electrolytic solution 52” or “electrolytic solution”). The separator 51 absorbs and holds the aqueous electrolytic solution 52. As the separator 51, a separator usable in an aqueous electrolyte secondary battery (such as a nickel-metal hydride battery, or a zinc-air battery) can be used. An example of such a separator includes a water-absorbing member such as a porous sheet or a nonwoven fabric made of a hydrophilic material (such as cellulose). The thickness of the separator 51 is not especially limited, and can be, for example, 5 μm to 1 mm. The aqueous electrolytic solution 52 contains a solvent containing water, and potassium pyrophosphate dissolved in the solvent.

The solvent of the aqueous electrolytic solution 52 contains water. The solvent may consist of water. In other words, in one embodiment, the aqueous electrolytic solution 52 can be an aqueous solution of a potassium salt of phosphorus oxoacid represented by the general formula K₂₊ₙPₙO₃ₙ₊₁, wherein n is an integer of 1 or more. For example, the aqueous electrolytic solution 52 can be a potassium pyrophosphate aqueous solution. In another embodiment, the solvent can further contain one or more nonaqueous solvents (organic solvents). Examples of such a nonaqueous solvent include one or more organic solvents selected from ethers, carbonates, nitriles, alcohols, ketones, amines, amides, sulfur compounds, and hydrocarbons. In one embodiment, the solvent composition (the content of water and the content of the nonaqueous solvent (a total content if a plurality of nonaqueous solvents is contained)) of the aqueous electrolytic solution 52 can be, with reference to the total amount (100% by mass) of the solvents contained in the aqueous electrolytic solution 52, water: nonaqueous solvent of 50 to 100% by mass: 0 to 50% by mass, or 70 to 100% by mass: 0 to 30% by mass, or 90 to 100% by mass: 0 to 10% by mass, or 95 to 100% by mass: 0 to 5% by mass.

In the aqueous electrolytic solution 52, a potassium salt of a phosphorus oxoacid represented by the general formula K₂₊ₙPₙO₃ₙ₊₁, wherein n is an integer of 1 or more (hereinafter referred to as the “P(V) oxoacid potassium salt”, a corresponding acid root sometimes being referred to as the “P(V) oxoacid root”) is dissolved as the electrolyte. The oxidation number of phosphorus in the salt is +V. In one embodiment, n can be 1, and in this case, the acid is potassium orthophosphate (K₃PO₄). In another embodiment, n can be an integer of 2 or more, and in this case, the salt is a potassium salt of a condensed phosphoric acid. In another embodiment, n can be 2, and in this case, the salt is potassium pyrophosphate (K₄P₂O₇). In another embodiment, n can be 3, and in this case, the salt is potassium triphosphate (K₅P₃O₁₀). In one embodiment, n can be, for example, 1 to 10, or 1 to 6, or 1 to 3. As the P(V) oxoacid potassium salt, one P(V) oxoacid potassium salt (namely, one having a single n) alone may be present in the aqueous electrolytic solution 52. A combination of P(V) oxoacid potassium salts having a plurality of different ns may be present in the aqueous electrolytic solution 52.

In the aqueous electrolytic solution 52, a dissociation equilibrium of the P(V) oxoacid potassium salt, and an acid dissociation equilibrium between an anion generated by complete or partial dissociation of the P(V) oxoacid potassium salt and a conjugate acid thereof can simultaneously hold up, and chemical species generated through these equilibriums are also encompassed in the “dissolved P(V) oxoacid potassium salt”. For example, when the P(V) oxoacid potassium salt is potassium pyrophosphate (n=2), the “dissolved potassium pyrophosphate” may be present in the electrolytic solution in the form of not only K₄P₂O₇ but also K⁺, K₃P₂O₇, K₃HP₂O₇, K₂P₂O₇²⁻, K₂HP₂O₇, K₂H₂P₂O₇, KP₂O₇³⁻, KHP₂O₇²⁻, KH₂P₂O₇, KH₃P₂O₇, P₂O₇⁴⁻, HP₂O₇³⁻, H₂P₂O₇²⁻, H₃P₂O₇, or H₄P₂O₇, or an association thereof. Besides, in the aqueous electrolytic solution 52, the “dissolved P(V) oxoacid potassium salt” may not be always one obtained by adding K₂₊ₙPₙO₃ₙ₊₁ to water. For example, the “dissolved potassium pyrophosphate” may not be always one obtained by adding K₄P₂O₇ to water. For example, a potassium ion source except for potassium pyrophosphate (such as K, KOH, K₂O, or CH₃COOK) and a pyrophosphate ion source (such as H₄P₂O₇) may be separately added to and dissolved in water. As a result, the ion and/or association may be formed in the water.

The content of the P(V) oxoacid potassium salt in the aqueous electrolytic solution 52 can be selected in accordance with a desired performance of the battery 10. In one embodiment, the content of the P(V) oxoacid potassium salt in the aqueous electrolytic solution 52 can be, in terms of K₂₊ₙPₙO₃ₙ₊₁, wherein n is given in accordance with the salt, 2.0 mol or more, 3.0 mol or more, or 5.0 mol or more per kg of water. The upper limit of the content is not especially limited, and in one embodiment, from the viewpoint of suppressing viscosity increase, the content can be 7.0 mol or less per kg of water in terms of K₂₊ₙPₙO₃ₙ₊₁, wherein n is given in accordance with the salt.

In one embodiment, when the P(V) oxoacid potassium salt is potassium orthophosphate, the content of the potassium orthophosphate in the aqueous electrolytic solution 52 can be 2.0 mol or more, 3.0 mol or more, or 5.0 mol or more per kg of water in terms of K₃PO₄. The upper limit of the content is not especially limited, and in one embodiment, from the viewpoint of suppressing viscosity increase, the content can be 7.0 mol or less per kg of water in terms of K₃PO₄.

In one embodiment, when the P(V) oxoacid potassium salt is potassium pyrophosphate, the content of the potassium orthophosphate in the aqueous electrolytic solution 52 can be 2.0 mol or more, 3.0 mol or more, or 5.0 mol or more per kg of water in terms of K₄P₂O₇. The upper limit of the content is not especially limited, and in one embodiment, from the viewpoint of suppressing viscosity increase, the content can be 7.0 mol or less per kg of water in terms of K₄P₂O₇.

In one embodiment, when the P(V) oxoacid potassium salt is potassium triphosphate, the content of the potassium triphosphate in the aqueous electrolytic solution 52 can be 2.0 mol or more, 3.0 mol or more, or 5.0 mol or more per kg of water in terms of K₅P₃O₁₀. The upper limit of the content is not especially limited, and in one embodiment, from the viewpoint of suppressing viscosity increase, the content can be 7.0 mol or less, or 6.0 mol or less per kg of water in terms of K₅P₃O₁₀.

In one embodiment, as the concentration of potassium pyrophosphate in the aqueous electrolytic solution is higher, the cycle characteristics are better, and high performance as a secondary battery can be attained.

The content of the “dissolved P(V) oxoacid potassium salt” in the aqueous electrolytic solution 52 is calculated as follows:
(1) The contents of water, a P(V) oxoacid root, and potassium in the electrolytic solution are measured.
(2-1) When (n+3)×a P(V) oxoacid root content (mol) is equal to or lower than a potassium content (mol), the P(V) oxoacid root content (mol) is specified as a P(V) oxoacid potassium salt content.
(2-2) When (n+3)×the P(V) oxoacid root content (mol) is not equal to or lower than the potassium content (mol), the potassium content (mol)/(n+3) is specified as the P(V) oxoacid potassium salt content.
(3) Based on the specified P(V) oxoacid potassium salt content (mol) and the water content (kg), the content of the P(V) oxoacid potassium salt (mol) per kg of water is calculated.

When the P(V) oxoacid potassium salt is a combination of a plurality of salts having different ns (namely, when the P(V) oxoacid root is a combination of a plurality of P(V) oxoacid roots having different ns), a sum of the contents (mol) of the plurality of P(V) oxoacid roots is used as the “P(V) oxoacid root content (mol)”, and in addition, the number average value of the ns of the plurality of P(V) oxoacid roots is used as the n in the inequality for the calculation. For example, when the P(V) oxoacid root is a combination (in a molar ratio of 1:1) of an orthophosphoric acid root (n=1) and a pyrophosphoric acid root (n=2), the number average value of the ns is 1.5. Alternatively, for example, when the P(V) oxoacid root is a combination (in a molar ratio of 1:1) of a pyrophosphoric acid root (n=2) and a triphosphoric acid root (n=3), the number average value of the ns is 2.5.

For example, when the P(V) oxoacid potassium salt is potassium pyrophosphate, calculation is made as follows:
(1) Regarding the content of the “dissolved potassium pyrophosphate” in the aqueous electrolytic solution 52, the contents of water, a pyrophosphoric acid root, and potassium in the electrolytic solution are measured.
(2-1) When 4× a pyrophosphoric acid root content (mol) is equal to or lower than a potassium content (mol), the pyrophosphoric acid root content (mol) is specified as a potassium pyrophosphate content (mol).
(2-2) When 4× the pyrophosphoric acid root content (mol) is not equal to or lower than the potassium content (mol), the potassium content (mol)/4 is specified as the potassium pyrophosphate content (mol).
(3) Based on the specified potassium pyrophosphate content (mol) and the water content (kg), the content of the potassium pyrophosphate (mol) per kg of water is calculated.

For measuring the water content, known measurement methods such as a dry method (such as a differential calorimetry method), and a Karl-Fischer method can be employed. For measuring the P(V) oxoacid root content, known measurement methods such as inductively coupled plasma-atomic emission spectroscopy (ICP-AES), chemiluminescence method, an ion chromatography method, absorptiometry employing a colorimetric method with molybdophosphoric acid generation, and absorption spectrophotometry with hetero-poly blue generation (Kosaburo Ohashi, et al., Bunsekikagaku (analytical chemistry), 1981, 30 (11), 727-731) can be employed. For measuring the potassium content, known measurement methods such as ICP-AES can be employed.

The aqueous electrolytic solution 52 may contain a larger amount of potassium ions than (n+3)×P(V) oxoacid root (mol). For example, when the P(V) oxoacid potassium is potassium pyrophosphate, the aqueous electrolytic solution 52 may contain a larger amount of potassium ions than 4× pyrophosphoric acid root (mol). An example of such a case includes a case in which a potassium ion source except for a potassium pyrophosphate source (such as KOH, or CH₃COOK) is added to and dissolved in water together with the potassium pyrophosphate source.

The aqueous electrolytic solution 52 may contain a cation except for a potassium ion, such as alkali metal ions except for a potassium ion, alkaline earth metal ions, and transition metal ions. Besides, the aqueous electrolytic solution may contain an anion except for the P(V) oxoacid root. For example, in the aqueous electrolytic solution 52, other electrolytes such as KPF₆, KBF₄, K₂SO₄, KNO₃, CH₃COOK, (CF₃SO₂)₂NK, KCF₃SO₃, and (FSO₂)₂NK may be further dissolved.

In one embodiment, the ratio of the P(V) oxoacid root occupying in the acid roots in the aqueous electrolyte solution 52, and the ratio of a potassium ion occupying in cations in the aqueous electrolytic solution 52 can be 50 to 100 mol %, or 70 to 100 mol %, or 90 to 100 mol %, or 95 to 100 mol %, or 99 to 100 mol % with respect to the total amount (100 mol %) of the acid roots in the aqueous electrolytic solution 52, and the total amount of the cations in the aqueous electrolytic solution 52.

The aqueous electrolytic solution 52 may contain, in addition to the solvent and the electrolytes, an acid, a hydroxide, or the like for adjusting the pH of the aqueous electrolytic solution, and may contain various additives.

The pH at 25° C. of the aqueous electrolytic solution 52 can be, for example, 3.0 to 13.0 or 7.0 to 13.0. In one embodiment, from the viewpoint of the width of the oxidation-side potential window, the pH can be 13.5 or less, or 13.0 or less, or 12.7 or less, or 12.5 or less. Besides, the pH can be 3.0 or more, or 4.5 or more, or 6.0 or more, or 7.0 or more. In one embodiment, the pH can be 3.0 to 13.5, or 4.5 to 13.0, or 6.0 to 12.7, or 7.0 to 12.5.

### External Material

The battery 10 is used in a state of being housed in the external material 6. As the external material 6, an external material usable in an aqueous electrolyte secondary battery can be used. Examples of such a material capable of constituting the external material include metal materials such as aluminum, and stainless steel, and resin materials such as a polyphenylene sulfide resin, and a polyimide resin. Besides, the shape of the external material is not especially limited, and the external material can be, for example, in a circular shape (such as a cylindrical shape, a coin shape, or a button shape), a hexahedral shape (such as a rectangular parallelepiped or a cubic shape), a bag shape, or a shape obtained by processing and deforming these shapes.

A conventional nickel hydrogen (Ni-MH) secondary battery typically uses a strongly basic potassium hydroxide aqueous solution as the electrolytic solution, a hydrogen storage alloy (MH) as the negative electrode active material, and nickel hydroxide and/or nickel oxyhydroxide as the positive electrode active material. Usually, in the positive electrode layer, nickel hydroxide having low conductivity is used as the positive electrode active material, and cobalt hydroxide having high conductivity is added thereto as the conductive aid. This is because when carbon is used as the conductive aid in the strongly basic potassium hydroxide aqueous solution, the carbon is oxidized to be degraded. Since cobalt hydroxide is added to the positive electrode, the cobalt hydroxide is oxidized in initial charge and changes to cobalt oxyhydroxide, and thus, the conductivity of the positive electrode is improved. Since the electrolytic solution is strongly basic, however, cobalt is easily eluted from the positive electrode layer (and a metal such as zinc or manganese from the hydrogen storage alloy), and these eluted metals precipitate on the separator, which can degrade an output characteristic and a self-discharge characteristic. On the contrary, in the aqueous battery of the present disclosure, since the aqueous electrolytic solution contains potassium pyrophosphate, although the pH of the aqueous electrolytic solution is mild acidic to mild basic, or neutral to mild basic, charge-discharge can be conducted with the hydrogen storage alloy used as the negative electrode active material. This means that aggression of the electrolytic solution against the metal materials of the negative electrode active material, the positive electrode active material, the current collectors, and the like can be reduced, and accordingly means that adverse influences derived from the elution of the metals into the electrolytic solution, and adverse influences of carbon on the oxidation reaction can be reduced. In the aqueous battery of the present disclosure, although the electrolytic solution is a potassium salt, the negative electrode active material probably stores and release a proton. When nickel hydroxide and/or nickel oxyhydroxide is used as the positive electrode active material, the positive electrode active material works also by storing and releasing a proton, and thus, a perfect protein battery is obtained. As the conductive aid in the positive electrode layer, a carbon material can be used instead of a conventionally used cobalt compound. Besides, as the positive electrode current collector and/or the negative electrode current collector, a metal material weak against a strongly basic group such as Al can be used instead of Ni that is excellent in corrosion resistance but expensive.

The present disclosure will now be more specifically described with reference to examples.

### 1. Preparation of Electrolytic Solution

As an electrolytic solution used for charge-discharge evaluation, 5.0 mol/kg and 1.0 mol/kg potassium pyrophosphate aqueous solutions (Examples 1 and 2), 28 mol/kg and 1.0 mol/kg potassium acetate aqueous solutions (Comparative Examples 1 and 2), a 22 mol/kg potassium trifluoromethanesulfonate aqueous solution (Comparative Example 3), a 21 mol/kg lithium bis(trifluoromethanesulfonyl)imide (LiTFSI) aqueous solution (Comparative Example 4), and a 6 mol/L potassium hydroxide aqueous solution (Reference Example 1) were respectively prepared. K₄P₂O₇ and KOH were purchased from Nacalai Tesque, Inc., CH₃COOK was purchased from FUJIFILM Wako Pure Chemical Corporation, CF₃SO₃K was purchased from Merck, and LiTFSI was purchased from Tokyo Chemical Industry Co., Ltd., and the purchased products were directly used. To each of the electrolytes, pure water was added to obtain a prescribed concentration of a resultant aqueous solution, followed by stirring. The mixture after the stirring was allowed to stand still in a constant temperature bath at 25° C. for one day or more, and thus, the electrolyte was completely dissolved.

### 2. Production of MH Coated Electrode

An electrode used for the charge-discharge evaluation was produced as follows. A hydrogen storage alloy (La₂Ni₇, hereinafter referred to as “MH”) and acetylene black were weighed and mixed homogeneously in a mortar. Styrene butadiene rubber (SBR), carboxymethylcellulose (CMC), and water were further added thereto, followed by homogeneously mixed again in a mortar. A mixing mass ratio was MH: acetylene black: SBR: CMC=75:20:4:1. A mixer (“Awatori Rentaro” manufactured by Thinky Corporation) was used for conducting a defoaming treatment at a rotational speed of 2000 rpm for 1 minute, and thus, an ink was prepared. The ink was dropped onto a titanium foil fixed on a glass plate, and was coated with a doctor blade having a gap of 150 μm. The resultant coated film was allowed to stand still under reduced pressure to be naturally dried, and then, was dried at 60° C. overnight with a vacuum dryer. An electrode obtained after the drying was punched into a circular shape having a diameter of 16 mm, and the resultant electrode was densified by pressing with a load of 1 ton.

### 3. Charge-Discharge Evaluation

A cell (VM4 manufactured by Inta-Kemi Co., Ltd.) including the MH coated electrode described above in 2. as a working electrode, a Ni mesh as a counter electrode, and a silver-silver chloride electrode (BAS) as a reference electrode was used to evaluate the respective electrolyte solutions described above in 1. for charge-discharge characteristics. VMP3 (manufactured by Biologic) was used as an apparatus, and a current density was set to ±0.1 mA/cm². A cutting condition on the oxidation current side was set to 0.2 V with respect to a standard hydrogen electrode (0 V with respect to a silver-silver chloride electrode), and a cutting condition on the reduction current side was set to 300 mAh/g (which was regulated in accordance with the capacity). Charge-discharge characteristics in 30 cycles were evaluated.

### 4. Results

### Example 1

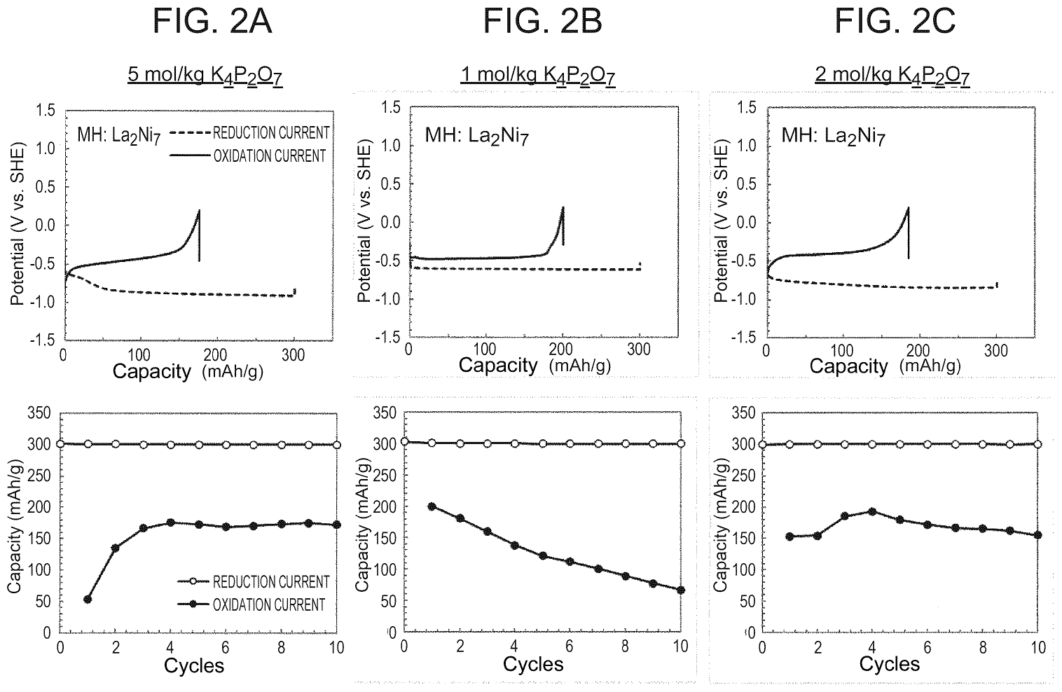

FIG. 2A illustrates charge-discharge characteristics (upper graph in FIG. 2A) and cycle characteristics (lower graph in FIG. 2A) obtained in using, as the electrolytic solution, a 5.0 mol/kg potassium pyrophosphate aqueous solution (pH: 12.2). Favorable charge-discharge activity, and high cycle stability were confirmed.

### Example 2

FIG. 2B illustrates charge-discharge characteristics (upper graph in FIG. 2B) and cycle characteristics (lower graph in FIG. 2B) obtained in using, as the electrolytic solution, a 1.0 mol/kg potassium pyrophosphate aqueous solution (pH: 10.6). Although the capacity was reduced comparatively early in accordance with the increase of the number of the charge-discharge cycles, favorable charge-discharge activity was exhibited at an initial stage.

### Example 3

FIG. 2C illustrates charge-discharge characteristics (upper graph in FIG. 2C) and cycle characteristics (lower graph in FIG. 2C) obtained in using, as the electrolytic solution, a 2.0 mol/kg potassium pyrophosphate aqueous solution (pH: 11.2). Favorable charge-discharge activity, and high cycle stability were confirmed.

### Example 4

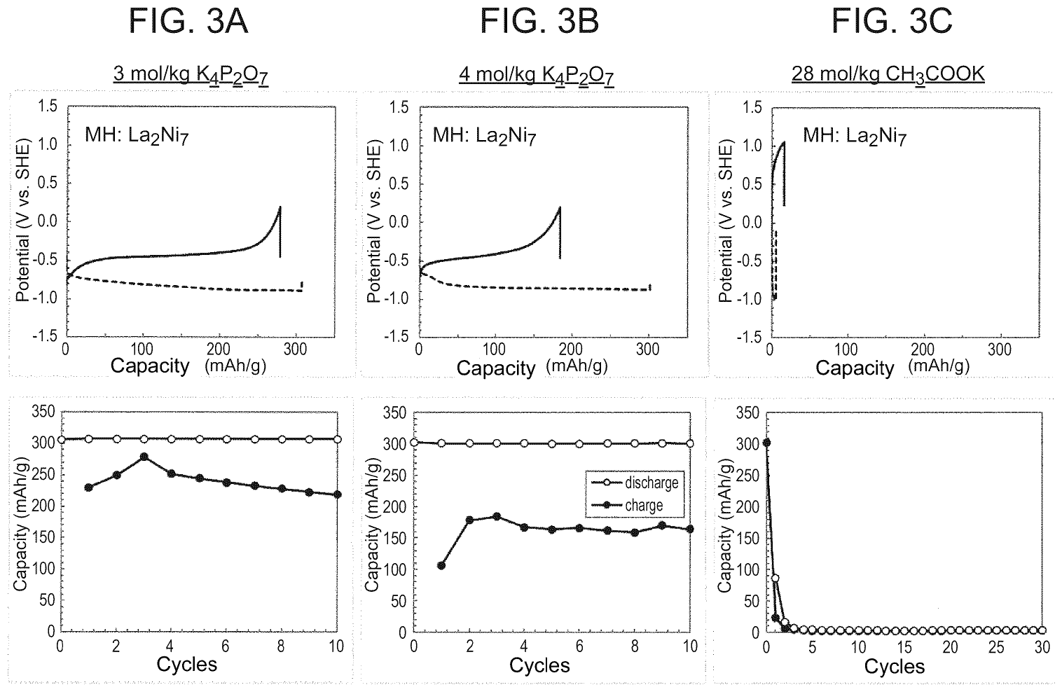

FIG. 3A illustrates charge-discharge characteristics (upper graph in FIG. 3A) and cycle characteristics (lower graph in FIG. 3A) obtained in using, as the electrolytic solution, a 3.0 mol/kg potassium pyrophosphate aqueous solution (pH: 11.7). Favorable charge-discharge activity, and high cycle stability were confirmed.

### Example 5

FIG. 3B illustrates charge-discharge characteristics (upper graph in FIG. 3B) and cycle characteristics (lower graph in FIG. 3B) obtained in using, as the electrolytic solution, a 4.0 mol/kg potassium pyrophosphate aqueous solution (pH: 11.9). Favorable charge-discharge activity, and high cycle stability were confirmed. In each of these examples, it is deemed that nickel hydroxide/nickel oxyhydroxide formed on the surface of the Ni mesh worked to store and release a proton in the positive electrode.

### Comparative Example 1

FIG. 3C illustrates charge-discharge characteristics (upper graph in FIG. 3C) and cycle characteristics (lower graph in FIG. 3C) obtained in using, as the electrolytic solution, a 28 mol/kg potassium acetate aqueous solution. An operation as a battery was minimally observed.

### Comparative Example 2

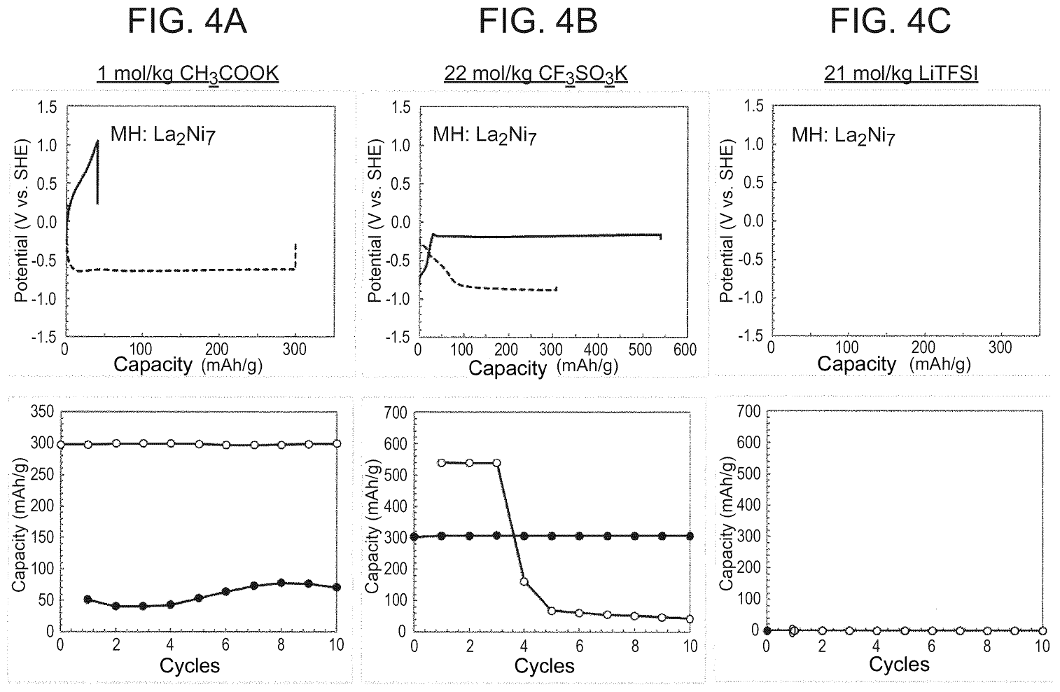

FIG. 4A illustrates charge-discharge characteristics (upper graph in FIG. 4A) and cycle characteristics (lower graph in FIG. 4A) obtained in using, as the electrolytic solution, a 1.0 mol/kg potassium acetate aqueous solution. An oxidation-side current minimally flowed.

### Comparative Example 3

FIG. 4B illustrates charge-discharge characteristics (upper graph in FIG. 4B) and cycle characteristics (lower graph in FIG. 4B) obtained in using, as the electrolytic solution, a 22 mol/kg potassium trifluoromethanesulfonate aqueous solution. At an initial stage of the cycle, a high capacity difficult to explain was exhibited, but the sample was rapidly degraded thereafter, and a characteristic not usable as a battery was exhibited. In this comparative example, the oxidation current may be derived from the elusion reaction of the hydrogen storage alloy.

### Comparative Example 4

FIG. 4C illustrates charge-discharge characteristics (upper graph in FIG. 4C) and cycle characteristics (lower graph in FIG. 4C) obtained in using, as the electrolytic solution, a 21 mol/kg LiTFSI aqueous solution. Neither charge nor discharge was observed, and this sample was completely inactive.

### Reference Example 1

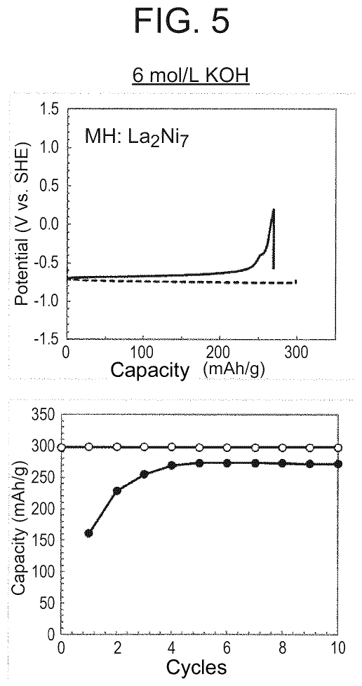

FIG. 5 illustrates charge-discharge characteristics (upper graph in FIG. 5) and cycle characteristics (lower graph in FIG. 5) obtained in using, as the electrolytic solution, a 6 mol/kg potassium hydroxide aqueous solution. This sample was confirmed to smoothly work as a battery. This result reveals that differences in the results among the other examples and comparative examples are derived from the electrolytic solutions used.

### Example 6

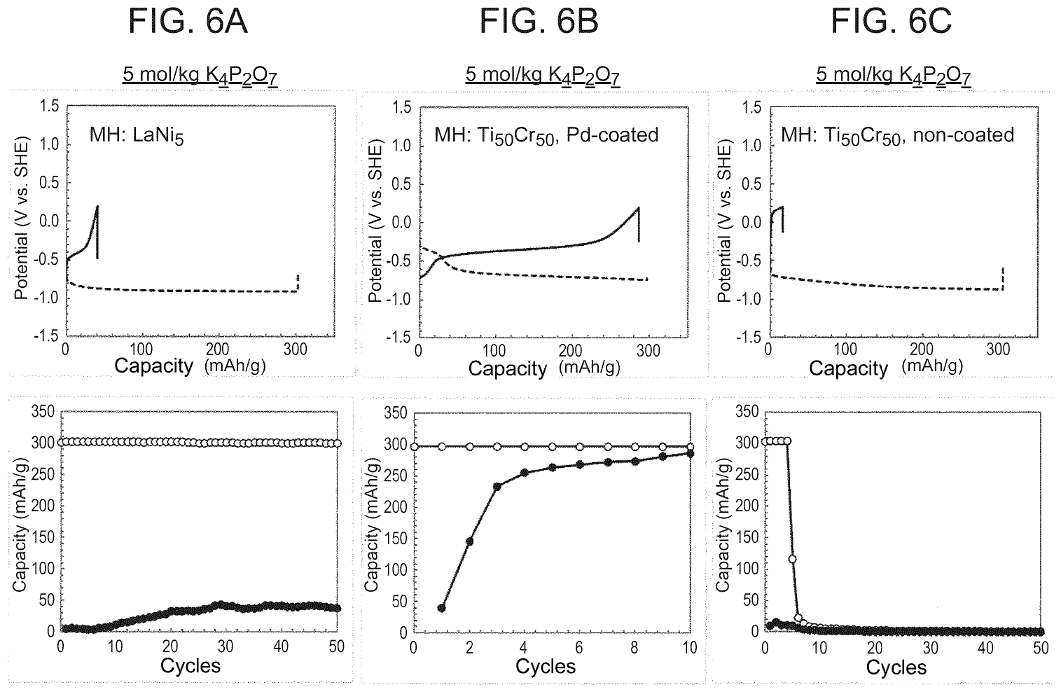

FIG. 6A illustrates charge-discharge characteristics (upper graph in FIG. 6A) and cycle characteristics (lower graph in FIG. 6A) obtained in using, as the electrolytic solution, a 5.0 mol/kg potassium phosphate aqueous solution (pH: 12.2) the same as that used in Example 1, and using, as the negative electrode active material, LaNi₅ instead of La₂Ni₇ used in Example 1. It was confirmed that even when the ABs-type hydrogen storage alloy is used as the negative electrode active material, the operation as a secondary battery can be conducted. The discharge capacity was, however, larger when La₂Ni₇ that is the A₂B₇-type hydrogen storage alloy was used. Besides, a comparatively large number of cycles was required for activating the negative electrode.

### Example 7

FIG. 6B illustrates charge-discharge characteristics (upper graph in FIG. 6B) and cycle characteristics (lower graph in FIG. 6B) obtained in using, as the electrolytic solution, a 5.0 mol/kg potassium phosphate aqueous solution (pH: 12.2) the same as that used in Example 1, and using, as the negative electrode active material, a Pd-coated Ti₅₀Cr₅₀ powder instead of La₂Ni₇ used in Example 1. In a TiₓCr₁₋ₓ-based alloy, Pd coating works as a catalyst phase. It was confirmed that even when a hydrogen storage alloy except for a La—Ni alloy is used as the negative electrode active material, the operation as a secondary battery can be conducted.

### Comparative Example 5

FIG. 6C illustrates charge-discharge characteristics (upper graph in FIG. 6C) and cycle characteristics (lower graph in FIG. 6C) obtained in using, as the electrolytic solution, a 5.0 mol/kg potassium phosphate aqueous solution (pH: 12.2) the same as that used in Example 1, and using, as the negative electrode active material, a Ti₅₀Cr₅₀ powder not coated with a catalyst instead of La₂Ni₇ used in Example 1. This sample substantially could not work as a secondary battery. This comparative example is different from Example 7 in that the Ti₅₀Cr₅₀ powder was not coated with Pd (not imparted with a catalyst). Since a TiₓCr₁₋ₓ-based alloy has a strong oxide film on the surface thereof, it is necessary to impart a catalyst phase of Pd or the like for causing the TixCr₁₋ₓ-based alloy to function as a hydrogen storage alloy. It was confirmed, based on the results of Example 7 and Comparative Example 5, that in the aqueous battery of the present disclosure, charge-discharge can be conducted by using, as the negative electrode active material, even an alloy except for a La—Ni-based material system as long as, and only when the alloy has hydrogen storing-releasing activity in an aqueous electrolytic solution (namely, the alloy functions as a hydrogen storage alloy).

What is claimed is:

1. An aqueous battery comprising:
a positive electrode containing a positive electrode active material;
a negative electrode containing a negative electrode active material; and
an aqueous electrolytic solution provided between the positive electrode and the negative electrode,
wherein the negative electrode active material contains a hydrogen storage alloy,
the aqueous electrolytic solution contains:
a solvent containing water; and
a potassium salt of a phosphorus oxoacid that is dissolved in the solvent, and represented by a general formula K₂₊ₙPₙO₃ₙ₊₁, wherein n is an integer of 1 or more.

2. The aqueous battery according to claim 1, wherein the potassium salt of the phosphorus oxoacid is potassium pyrophosphate.

3. The aqueous battery according to claim 2, wherein a content of the potassium pyrophosphate in the aqueous electrolytic solution is, in terms of K₄P₂O₇, 2.0 mol or more per kg of water.

4. The aqueous battery according to claim 2, wherein pH at 25° C. of the aqueous electrolytic solution is 3.0 to 13.0.

5. The aqueous battery according to claim 1, wherein the positive electrode active material is capable of storing and releasing a hydrogen ion.
